(19) United States
(12) Patent Application Publication
(10) Pub. No.: US 2020/0269829 A1
(43) Pub. Date: Aug. 27, 2020

(54) APPARATUS AND METHOD FOR THERMAL CONTROL

(71) Applicant: JAGUAR LAND ROVER LIMITED

(72) Inventor: Nick Brockley, Whitley, Coventry, Warwickshire (GB)

(21) Appl. No.: 16/319,640

(22) PCT Filed: Jun. 8, 2017
(86) PCT No.: PCT/EP2017/064029

§ 371 Date: Jan. 22, 2019

(30) Foreign Application Priority Data
Jul. 26, 2016 (GB) 1612886.0

(51) Int. Cl. B60W 20/00; F01P 7/16; B60W 10/06; B60W 10/10; B60W 10/08; G01C 21/34

(52) U.S. Cl. CPC B60W 20/00; F01P 7/167; B60W 10/06; B60W 10/10; B60W 2552/05; G01C 21/3407; F01P 2025/66; B60W 2520/10; B60W 10/08

(57) ABSTRACT

Embodiments of the present invention provide a thermal control method for a vehicle, comprising determining (110), based on a location of a vehicle and digital map data (220), an estimate of at least one vehicle operating condition at one or more future points in time, determining (130), for each of the future points in time, a desired operating temperature for a module of the vehicle based on the associated at least one vehicle operating condition, and controlling (150), in advance of at least one of the future points in time, one or more thermal control means (20) associated with the vehicle to direct an operating temperature of the module to the desired operating temperature at the respective future point in time.

### TECHNICAL FIELD

The present disclosure relates to a thermal control method and thermal controller. Aspects of the invention relate to a thermal control method for a vehicle, to a thermal controller for a vehicle, to a vehicle and to a computer readable medium having computer-executable instructions.

### BACKGROUND

It is continually desired to improve fuel economy of a vehicle, particularly although not exclusively, vehicles powered at least partly by combustion engines. One technique used for improving economy is thermal control. For example, engine temperature is controlled to achieve, often, improved economy but may also be controlled to improve performance of the engine such as power output. However controlling the temperature of vehicle modules, such as engine but also power train modules such as gearbox, differentials etc., is difficult due to slow thermal response of such modules.

It is an object of embodiments of the invention to at least mitigate one or more of the problems of the prior art.

### SUMMARY OF THE INVENTION

Aspects and embodiments of the invention provide a thermal control method for a vehicle, to a thermal controller for a vehicle, to a vehicle and to a computer readable medium as claimed in the appended claims.

According to an aspect of the invention, there is provided a thermal control method for a vehicle, comprising determining, based on digital map data, an estimate of at least one vehicle operating condition, determining, a desired operating temperature for a module of the vehicle based on the associated at least one vehicle operating condition, and controlling, one or more thermal control means associated with the vehicle to direct an operating temperature of the module to the desired operating temperature. Advantageously the digital map data is used to control, in advance, the temperature of the module.

According to an aspect of the invention, there is provided a thermal control method for a vehicle, comprising determining, based on a location of a vehicle and digital map data, an estimate of at least one vehicle operating condition at one or more future points in time, determining, for each of the future points in time, a desired operating temperature for a module of the vehicle based on the associated at least one vehicle operating condition, and controlling, in advance of at least one of the future points in time, one or more thermal control means associated with the vehicle to direct an operating temperature of the module to the desired operating temperature at the respective future point in time. Advantageously the digital map data is used to control, in advance the one or more future points in time, the temperature of the module.

The method may comprise determining a utilisation parameter indicative of utilisation of the module of the vehicle based on the estimate of the at least one vehicle operating condition. Advantageously, the utilisation of the module is determined which may influence the temperature of the module.

The desired operating temperature for the module of the vehicle is determined in dependence on the utilisation parameter. Advantageously, the utilisation of the module is determined which may influence the temperature of the module.

The desired operating temperature of the module may be determined to be inverse to the utilisation parameter. Advantageously efficiency of the module may be improved by operating at lower temperatures corresponding to higher utilisation.

The module of the vehicle is optionally one of a power unit or power train of the vehicle. The power unit may comprise one or more of an engine and electric motor. The power train may comprise a gearbox of the vehicle. Advantageously the module may be associated with motion of the vehicle.

The thermal control means may be a thermostat associated with the module. The controlling may comprise controlling a set-point of the thermostat. Advantageously the set-point is used to control the operating temperature of the module.

The controlling may comprise determining a control time, in advance of the at least one of the future points in time, to control the thermal control means such that the operating temperature is directed toward the desired operating temperature at the at least one of the future points in time. Advantageously, the thermal control means is operated in advance to direct the operating temperature of the module.

The control time is optionally determined based on the utilisation of the module preceding the at least one of the future points in time. Advantageously, a current utilisation of the module may be taken advantage of to control the future temperature.

The controlling may be based upon a thermal response model for the module. The thermal response model may be indicative of a temporal relationship of the operating temperature of the module to operation of the thermal control means. Advantageously the thermal response model assists in achieving a correct operating temperature.

The control time may be determined based on the thermal response model and one or more attributes of the module. The operating temperature of the model may be directed toward the desired operating temperature at the respective future point in time. The one or more attributes optionally comprise a current temperature of the module. Advantageously attributes of the module are used in consideration by the model of the desired operating temperature.

The utilisation parameter may be determined based upon a vehicle dynamics model for the vehicle. Advantageously the vehicle dynamics model assists in determining the utilisation of the module.

The utilisation parameter may be a duty cycle of the module and the vehicle dynamics model may be indicative of a relationship between the at least one vehicle operating condition and the duty cycle. The vehicle operating condition may comprise one or more of vehicle speed, vehicle gradient and a vehicle altitude. Advantageously, the vehicle operating condition is used to determine the utilisation parameter of the module.

The determining the estimate of at least one vehicle operating condition optionally comprises predicting at least one future location of the vehicle at the one or more future points in time based on the digital map data. Advantageously the map data is used to estimate, in advance, the at least one vehicle operating condition.

The future location of the vehicle may be predicted based on route information indicative of a route to be followed by the vehicle. Advantageously, the route information may provide a higher degree of confidence for the future location.

The method optionally comprises determining a road category associated with the at least one future location. The estimate of the at least one vehicle operating condition may comprises an estimated speed of the vehicle at the at least one future location based on the road category. Advantageously, the determination of the road category allows the operating condition to be better estimated.

The digital map data may be electronic horizon data. The electronic horizon data optionally comprises topology data. Advantageously, the utilisation of the module may be determined based on the topology data, which determination may include consideration of elevations and/or gradient.

According to a still further aspect of the invention there is provided a thermal controller for a vehicle, comprising location determining means for determining a location of the vehicle, processing means for determining an estimate of at least one vehicle operating condition at one or more future points in time based on digital map data stored in a memory means accessible to the processing means, wherein the processing means is arranged to determine, for each of the future points in time, a desired operating temperature for a module of the vehicle based on the associated at least one vehicle operating condition, and wherein the processing means is arranged control, in advance of at least one of the future points in time, one or more thermal control means associated with the vehicle to direct an operating temperature of the module to the desired operating temperature at the respective future point in time.

The processing means may be arranged to determine a utilisation parameter indicative of utilisation of the module of the vehicle based on the estimate of the at least one vehicle operating condition.

The desired operating temperature for the module of the vehicle is optionally determined in dependence on the utilisation parameter.

The desired operating temperature of the module may be determined to be inverse to the utilisation parameter.

The module of the vehicle may be one of a power unit or power train of the vehicle. The power unit optionally comprises one or more of an engine and electric motor. The power train may comprise a gearbox of the vehicle.

The thermal control means may be a thermostat associated with the module. The controlling may comprise controlling a set-point of the thermostat.

The controlling optionally comprises controlling a current applied to a heating device associated with the thermostat to control the set-point.

The location determining means may comprise an input for receiving location data indicative of a geographic location of the vehicle.

The controlling the one or more thermal control means may comprise outputting data to initiate an operation of the thermal control means.

The controlling may be based upon a thermal response model for the module, the thermal response model being indicative of a temporal relationship of the operating temperature of the module to operation of the thermal control means.

The control time may be determined based on the thermal response model and one or more attributes of the module. The operating temperature of the model may be directed toward the desired operating temperature at the respective future point in time. The one or more attributes may comprise a current temperature of the module.

The utilisation parameter may be determined based upon a vehicle dynamics model for the vehicle.

The utilisation parameter may be a duty cycle of the module and the vehicle dynamics model is indicative of a relationship between the at least one vehicle operating condition and the duty cycle.

According to a yet further aspect of the invention there is provided a vehicle comprising a thermal controller according an aspect of the invention.

According to another aspect of the invention there is provided computer software which, when executed by a computer, is arranged to perform a method according to an aspect of the invention. The computer software may be stored on a computer readable medium. The computer software may be tangibly stored on a computer readable medium.

Any control unit or controller described herein may suitably comprise a computational device having one or more electronic processors. The system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller or control unit, a suitable set of instructions may be provided which, when executed, cause said control unit or computational device to implement the control techniques specified herein. The set of instructions may suitably be embedded in said one or more electronic processors. Alternatively, the set of instructions may be provided as software saved on one or more memory associated with said controller to be executed on said computational device. The control unit or controller may be implemented in software run on one or more processors. One or more other control unit or controller may be implemented in software run on one or more processors, optionally the same one or more processors as the first controller. Other suitable arrangements may also be used.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described by way of example only, with reference to the accompanying drawings, in which:

FIG. 1 shows a method according to an embodiment of the invention;

FIG. 2 shows a thermal controller according to an embodiment of the invention;

FIG. 3 shows an illustration of a portion of map data according to an embodiment of the invention;

FIG. 4 is a data flow diagram illustrating operation of an embodiment of the invention;

FIG. 5 shows a timing graph illustrating operation of embodiments of the invention; and

FIG. 6 shows a vehicle according to an embodiment of the invention.

### DETAILED DESCRIPTION

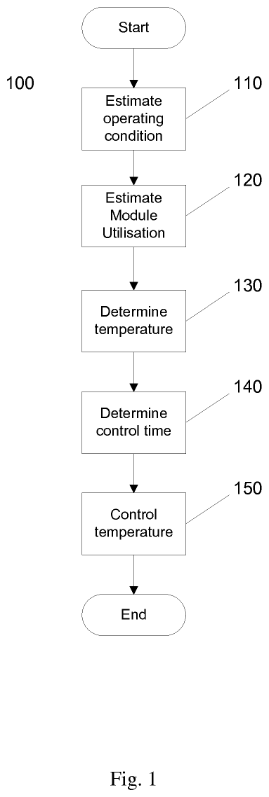

FIG. 1 illustrates a thermal control method 100 according to an embodiment of the invention. The thermal control method is for operatively controlling a temperature of one or more vehicle modules, as will be explained.

An embodiment of the method 100 will be explained with reference to FIG. 2 which illustrates a thermal control means 200 in the form of a thermal controller 200 according to an embodiment of the invention. The thermal controller 200 comprises processing means 210, map data means 220 and data storage means 230. The thermal controller 200 is communicatively coupled, in use, to location determining means 10 for determining a geographic location and thermal control means 20 for controlling an operating temperature of a module of a vehicle.

The processing means 210 may be provided in the form of one of more processing devices for operatively executing computer-executable instructions, wherein the instructions may be stored in a computer-readable medium, such as data storage means 230. The computer-executable instructions may implement an embodiment of the method 100 illustrated in FIG. 1.

The map data means 220 provides digital map data. As will be appreciated, digital map data is data indicative of navigable paths or routes which may be in the form of roads, although other paths such as vehicle-accessible tracks and the like may also be included in the map data. Typically digital map data provides a representation of such navigable paths as a series of interconnected nodes, wherein the interconnections represent roads and are associated with attributes such as one or more of a road category, speed limit, and average travelling speed, which may be based on actual data from vehicles travelling along the path. The digital map data may, in some embodiments, be horizon data or electronic-horizon data (e-horizon data) which includes topographical data. For example the e-horizon data may be indicative one or more of an altitude of each path or a gradient of at least a portion of the path. It will be realise that the digital map data may be stored in formats other than interconnected nodes. The map data means 220 may be formed by one or more data storage devices, such as memory devices, having the digital map data stored therein.

However in other embodiments the digital map means 220 may provide access to remotely stored digital map data such as via a communications link.

The data storage means 230 is formed by one or more data storage devices such as memory devices. The data storage means 230 stores a thermal response model 240 and a vehicle dynamics model 250. The thermal response model 240 is indicative of a temporal relationship of the operating temperature of the module to operation of the thermal control means 20. The vehicle dynamics model 250 is indicative of a relationship between at least one operating condition for the vehicle and utilisation of at least one module of the vehicle. In particular, in some embodiments the vehicle dynamics model 250 is used to determine utilisation or a duty cycle of the at least one module of the vehicle based on the at least one operating condition for the vehicle, as will be explained.

In some embodiments of the invention the at least one operating condition comprises a speed of the vehicle at each of one or more future points in time. The one or more future points in time may be one or more predetermined time periods in advance of the current time. In some embodiments the at least one operating condition comprises an altitude of the vehicle at each of the future points in time. It will be realised that other operating conditions of the vehicle may be determined. The one or more operating conditions are used to determine a duty cycle of at least one module of the vehicle. It will be appreciated that the duty cycle is indicative of a power output or throughput of the module. In some embodiments the one or more modules are at least one power unit or power train module of the vehicle. Thus such embodiments comprise determining the duty cycle of one or more power units of the vehicle, wherein the power unit provides a motive force for the vehicle. The power unit may be one or a combination of an engine or electric motor used to propel the vehicle. The duty cycle may be indicative of the power output of the power unit.

Referring again to FIG. 1, the method comprises a step 110 of determining an estimate of at least one vehicle operating condition at the one or more future points in time. The estimate is based on a location of a vehicle and digital map data. The location of the vehicle is a current geographic location of the vehicle, such as may be identified with a predetermined coordinate system for example latitude and longitude, although other coordinate or reference systems may be used.

The location of the vehicle may be determined by the location determining means 10 which may operate based on received wireless signals such as received form one or more navigation satellites, although it will also be appreciated that other wireless signals may be utilised such as communication signals i.e. of a mobile telecommunications network or data network, such as WiFi and the like. Thus, in some embodiments, the location determining means 10 may comprises a wireless signal receiving device for receiving wireless navigation signals.

The location of the vehicle is compared against the digital map data obtained from the map data means 220 in order to determine at least one likely location for the vehicle at the one or more future points in time. The one or more future points in time may include, for example, the likely location for the vehicle in 1 minute, 2, minutes, 5 minutes etc. It will be realised that these future points in time are only provided as examples and that other points in time may be selected.

In some instances a route may be programmed into a navigation system of the vehicle of which the location determining means 10 may form part. Thus the at least one likely location for the vehicle at the one or more future points in time may correspond to one or more positions or locations along the route. In some embodiments a destination of the vehicle may be inferred and thus an inferred route from the current location to the destination determined. The destination may be inferred from information such as current time, current day of week etc. and based on historic journey information for the vehicle which may indicate that, for example, on weekdays at approximately 6 pm the vehicle is usually being driven to a home destination. Therefore it is not necessary for a destination location to have been explicitly selected in order to utilise route information to estimate the future location(s) for the vehicle.

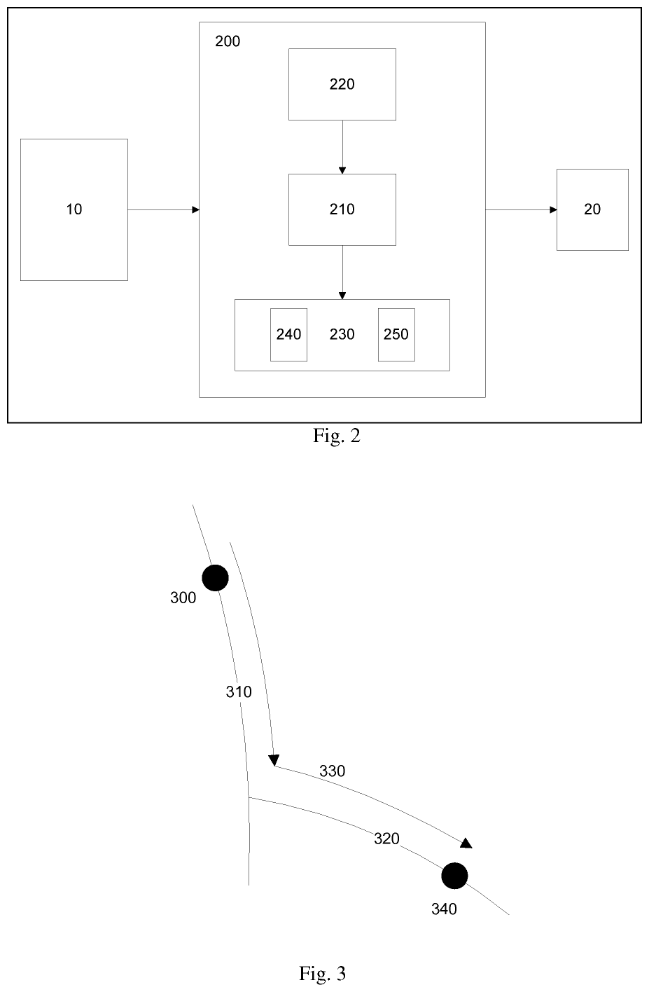

Referring to FIG. 3, an example portion of digital map data is illustrated. The portion comprises a first road segment 310 and a second road segment 320 adjoining the first road segment 310. A current location of the vehicle is indicated as 300 along the first road segment 310. A route 330 is illustrated by arrows which takes the second road segment 320. Thus the estimated location 340 of the vehicle at a future point in time, such as 1 minute ahead of the current time, is indicated as 340 along the route. The estimated location 340 of the vehicle at the future point in time may be determined based upon speed limit information or historical speed information associated with each road segment i.e. to determine how far from the current location 300 the vehicle travels within the time period ahead of the current time.

In other situations, at each future point in time there may exist a plurality of potential locations, such as a first potential location along a current road on which the vehicle is currently travelling and a second potential location along a road connected to the current road. A probability may be determined for each potential location and a location having the highest probability selected. The probability may be determined based on information associated with each road in the digital map data, such as being indicative of a class of each road e.g. motorway, major road, minor road etc., wherein higher road classes have the highest probability of being utilised. It will be appreciated that the probability may be determined in other ways. Thus the estimate location 340 may be selected from amongst a plurality of potential locations for each future point in time.

For each estimated location 340 of the vehicle, an estimate of at least one vehicle operating condition is determined in step 110. The operating condition may be a speed of the vehicle at the estimated location 340. The speed of the vehicle may be estimated based on one or more of a road class corresponding to the estimated location 340, speed limit information or historical speed information associated the road segment 320 corresponding to the estimated location 340. The speed limit information identifies a speed limit of the road segment whilst the historical speed information identifies an average travelling speed of vehicles on the road segment 320, which may based on probe information, such as derived from a community of navigation devices. Thus, for example, the speed of the vehicle may be estimated to be 50 kmh⁻¹ for a future point in time 1 minute ahead and, for example, 90 kmh⁻¹ for a future point in time 5 minutes ahead. It will be appreciated that these figures are provided by way of illustration.

In some embodiments, where the digital map data is e-horizon data, for each future point in time one or more of a gradient of the road segment at the estimated location 330 or an altitude of the vehicle at the estimated location 330 may be determined. Other attributes may also be determined for each estimated location.

In some embodiments, step 120 comprises determining a utilisation parameter indicative of utilisation of the module of the vehicle based on the estimate of the at least one vehicle operating condition. The utilisation parameter may be indicative of the duty or duty cycle of the module. Illustration will be made by referring to an engine of the vehicle as the module, although as noted above the module may be another component of the vehicle. The duty cycle is indicative of the power output by the engine required to achieve the one or more operating conditions of the vehicle at the estimated location 340. For example, it can be appreciated that a greater duty cycle of the engine is required to achieve a vehicle operating speed of 90 kmh⁻¹ than 50 kmh⁻¹ and, furthermore, in some embodiments a greater duty cycle to achieve the same speed on a road having a gradient of 5% than a flat road or at a higher altitude.

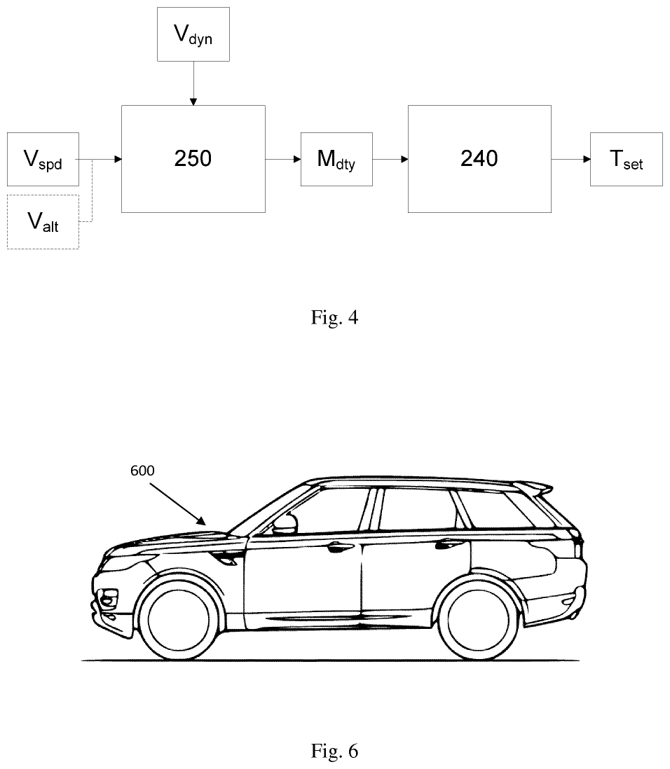

In order to determine the duty cycle at the future point in time, the vehicle dynamics model 250 is provided, as an input, with information indicative of the at least one operating condition associated with the future point in time, such as at location 340. Referring to the illustration in FIG. 4, the vehicle dynamics model 250 is provided, in one embodiment, with the speed of the vehicle at the future point in time (V_{spd}) and, optionally, the gradient of the road (V_{grad}) or altitude (not shown) at the estimated location 340 corresponding to the future point in time. It will be appreciated that the altitude of the road may be used in place of, or in addition to the gradient. The vehicle dynamics model 250 may also receive or comprise data indicative of one or more dynamic properties of the vehicle such as one or more of vehicle mass, aero losses of the vehicle, cross-sectional area, drag coefficient, rolling resistance, running losses etc., for determining the module's duty cycle (M_{dty}), such as the engine's duty cycle. In particular, in one embodiment, the vehicle dynamics model 250 determines a required power output of the power unit or engine of the vehicle to achieve the one or more vehicle operating conditions based on dynamic information associated with the vehicle. Thus, for the future estimated location 340 of the vehicle, an estimate of the module's utilisation, such as duty cycle of the engine, is determined.

In step 130 at least one desired operating temperature for the module of the vehicle is determined. A desired operating temperature for the module may be determined for each future point in time and corresponding estimated location 340 of the vehicle as determined in step 110. The desired operating temperature is based on the associated at least one vehicle operating condition provided from step 110. In particular, in some embodiments of the invention the desired operating temperature for the module of the vehicle is determined based on the utilisation parameter or, more particularly in one embodiment, based on the duty cycle M_{dty}. The desired operating temperature may be an operating temperature for improving efficiency of operation of the module, such as the engine of the vehicle. However it will also be appreciated that the operating temperature may be selected to improve, for example, a power output of the module in some embodiments, such as increasing powertrain performance.

As an example, reference will be made to an embodiment in which the operating temperature of the vehicle engine is controlled for efficiency i.e. to reduce fuel consumption.

In such embodiments the operating temperature of the engine may be controlled to be inverse to the duty cycle or power demand of the engine. That is, where the engine is required to have a greater duty cycle i.e. to output more power, the desired operating temperature is lower than where the engine has a lower duty cycle or less output power. At higher duty cycles a lower operating temperature of the engine allows higher efficiency due to allowing more optimal ignition timing on gasoline engines. At lower duty cycles higher operating temperature may reduce frictional losses within the engine or powertrain.

The desired operating temperature may be determined by the processing means 210 according to an algorithm or look-up table stored in the data storage means 230 based on the duty cycle.

It will be appreciated that, in some embodiments, an operating temperature of the engine may be controlled by a thermostat associated with the engine. The thermostat forms part of a cooling system for the engine such as where coolant liquid is circulated, at least for some of the operation time, through the engine. The thermostat senses the operating temperature of the engine and controls the flow of the coolant liquid through the engine in dependence thereon. A set-point is a temperature at which the thermostat operates or switches i.e. defining an upper operating temperature for the engine before cooling is applied thereto. At the set-point the thermostat controls the cooling system to cool the engine.

The thermostat may comprise a heating means for heating the thermostat to adjust the set-point of the thermostat. A temperature control means, such as heating means, may be used in the thermostat to adjust the set-point of the thermostat. By applying heat from the heating means to the thermostat the heat from the engine required to cause switching of the thermostat is reduced, thereby adjusting the set-point of the thermostat. The heating means may be a heating device, such as a heating element, arranged to heat the thermostat in dependence on an electrical signal applied to the heating device. Thus as an electrical current applied to the heating device causes heating of the thermostat the thermostat's set point is caused to reduce, thereby reducing an operating temperature of the engine.

Thus a thermal control means 20, such as thermostat, is provided for controlling an operating temperature of the module of a vehicle. It will be appreciated that other modules of the vehicle have appropriate thermal control means. For example, the thermal control means may be a water cooled charge air cooler (WCAC) or valve to allow a cooling or heating medium such as oil or water flow through the module.

As part of step 130 one or more set points for the thermal control means 20 may be determined. The one or more set points may be determined based on the desired operating temperature determined in step 130 for each future point in time. In one embodiment, a set point may be determined for each corresponding desired operating temperature. For example, a future point in time F₁ a desired operating temperature of the module Temp₁ may be determined and a corresponding set-point Tₛₑₜ₁ of the thermal control means 20. A desired operating temperature and set-point of the thermal control means 20 may be determined for each of the future points in time. The set-point for the thermal control means 20 may be determined by the thermal response model 240 based on the duty cycle M_{dty}. Therefore, as a result of step 130, a desired temperature for the module at the estimated future location 340 is determined based on the module's estimated utilisation at that location 340.

In step 140 a time at which to control the temperature of the module is determined. In step 140 the control time for the module's temperature may be determined, as will be explained. As noted above in relation to step 110, the operating condition of the vehicle is determined for a future point in time, such as, for example 1 or 5 minutes ahead of the current time. For this future point in time the module's utilisation is determined in step 120, which may be the duty cycle M_{dty} of the vehicle's engine and, based on the utilisation, the desired operating temperature for the module determined for that point in time. However, it can be appreciated that temperature control of such modules is not instantaneous. For example, reducing the module's temperature may require a period of time for cooling of the module. Also, particularly where the desired temperature is inverse to the module's utilisation, such as for the engine, where it is desired to increase the temperature of the engine, it may be advantageous to cause the increase in engine temperature at a point in time at which the duty cycle of the engine is higher to utilise internally generated heat. In other words, if at the future point in time the engine's duty cycle will be lower than at a preceding time and thus generate less heat, advance control may more efficiently raise the temperature of the engine. Where the set-point of a thermostat is controlled by heating the thermostat, a response time of 2-3 minutes may be required to adjust the set-point, although it will be realised that this period of time is an example.

The thermal response model 240 models a temporal relationship between the operating temperature of the module and operation of the thermal control means 20. The thermal response model determines a time at which the thermal control means 20 is to be operated in dependence on the desired operating temperature for the module. In one embodiment, the thermal response model models a relationship between the set-point of the thermostat and the actual operating temperature of the engine. The thermal response model 240 may take into account, i.e. receive as an input, a current operating temperature of the module. As indicated in FIG. 4, the thermal response model 240 determines the thermal set point Tₛₑₜ and a corresponding point in time Tₜᵢₘₑ at which to operate the thermal control means 20. Operation of the thermal control means 20 may comprise heating the thermostat associated with the vehicle's engine, although it will be realised that other thermal control means may be used.

Step 150 comprises operating the thermal control means 20 at an appropriate point in time to control the module's temperature. As will be explained, operating the thermal control means may cause applying a current to the heater associated with the thermostat to adjust the set-point of the thermostat and, consequently, controlling the operating temperature of the engine.

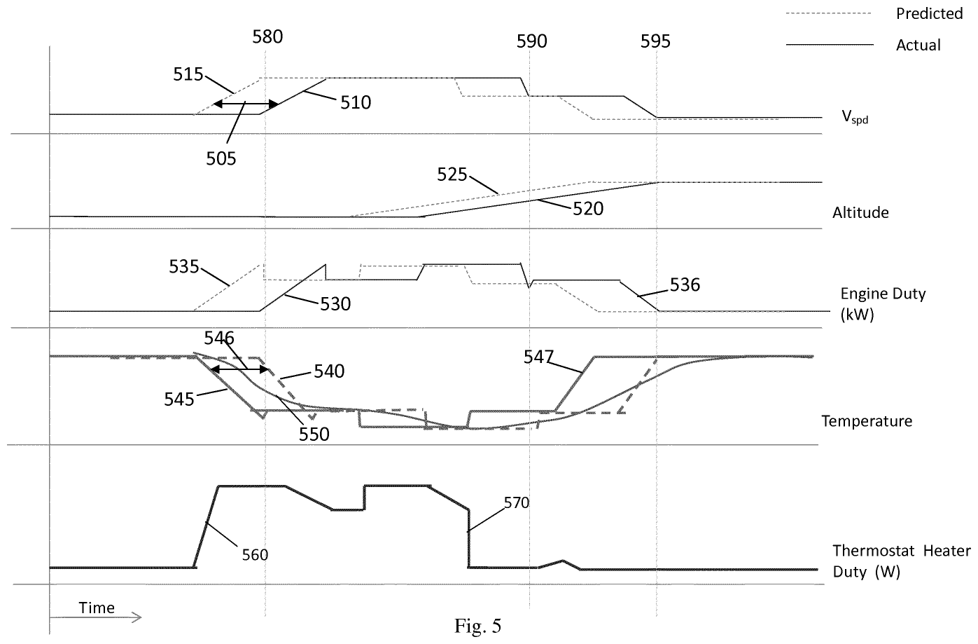

FIG. 5 is a timing graph illustrating an embodiment of the invention. FIG. 5 illustrates vehicle speed V_{spd}, vehicle altitude, engine duty M_{dty}, engine temperature and thermostat heater duty against time (y-axis). In FIG. 5, actual measurements are indicated with solid lines, whereas predicted measurements or estimates of relevant parameters are indicated with dashed lines.

As can be appreciated from trace 510 which indicates actual vehicle speed (V_{spd}), at time indicated by reference 580 the vehicle joins a major road or enters a road segment having a higher speed limit, and thus the speed of the vehicle gradually increases and then maintains at a first relatively constant speed for most of the duration of that road segment before slowing to a second lower speed at time indicated by reference 590 and similar immediately preceding time 595 to a third lower speed.

In step 110 of the method 100, the operating condition in the form of, in one embodiment, estimated vehicle speed 515 is determined for a future point in time. As indicated by arrow 505, the future point in time is a predetermined time ahead of the current time, such as 1, 2 or 5 minutes although other time periods may be used. Thus the estimated vehicle speed is determined based on the map data and current location, and is indicated by line 515. As can be appreciated, the estimated vehicle speed provides advanced information about operation of the vehicle. Similarly, as indicated by line 520 indicative of actual vehicle altitude, the estimated altitude 525 of the vehicle may be determined in advance in some embodiments of the invention.

In step 120, utilisation of the module is determined based on the operating condition. In the embodiment illustrated in FIG. 5, the module of the vehicle is the engine and the duty cycle of the engine is determined. The duty cycle may be determined in the form of power output (kW) of the engine. As illustrated, actual duty cycle of the engine is illustrated with solid line 530 and estimated duty cycle, determined in advance, is indicated with dotted line 535.

Based on the utilisation of the module, or in particular in the illustrated embodiment the duty cycle of the engine, a desired operating temperature for the engine is determined, as in step 130 and indicated with line 540. As can be appreciated, it is desired for the engine temperature, in the illustrated embodiment, to fall immediately following time 580 as the engine duty cycle increases and to rise preceding time 595 as the engine duty cycle decreases. Optimally the engine temperature would change simultaneously with the corresponding change in engine duty cycle. However, in order to achieve an actual temperature of the engine, as indicated with line 550 approximating the desired operating temperature, it is necessary to operate thermal control means 20 in advance i.e. to allow for thermal inertia of the engine, particularly for allowing cooling of the engine, but also to allow for heating of the engine i.e. the engine's temperature to rise when thermal energy is available.

A set-point of the thermostat associated with the engine is indicated by line 545 which, as discussed, controls the engine's temperature. The set-point is influenced, in one embodiment, by heating of the thermostat by a heating device. A duty (W) or power output of the thermostat heating device is indicated in FIG. 5, particular with numeral 560 indicating a rise in duty and 570 indicating a fall in duty. As can be appreciated, the duty of the heater rises 560 in advance of a time at which it is desired for the engine temperature to fall. The rise in heater duty 560 causes a corresponding lowering of the thermostat set-point 545. As a result, the engine temperature falls partly in advance of the time 580 at which the duty cycle of the engine begins to rise and continues to fall for at least some of the time for which the duty cycle of the engine rises after time 580. The lead time 546 for which the set-point of the thermostat is caused to fall ahead of the desired, or optimal, set-point indicated as 540 is illustrated in FIG. 5 and is determined by the thermal response model, as discussed above.

Specifically indicated in FIG. 5 with reference numeral 536 is a fall in duty cycle of the engine preceding time 595. The fall in duty cycle corresponds to an increase in the desired, or optimal, engine temperature at the same time. However, if the thermal control means 20 were only operated responsive to the fall in duty cycle of the engine, achieving a rise in engine temperature would be difficult or slow due to the lower amount of thermal energy generated by the engine at lower duty cycles. However, embodiments of the invention advantageously cause a rise in engine temperature in advance of the fall in duty cycle 536 by operating the thermal control means in advance, for example causing an increase in set-point of the thermostat when the duty cycle of the engine is higher, as indicated by numeral 547.

FIG. 6 illustrates a vehicle 600 according to an embodiment of the invention. The vehicle 600 comprises a thermal controller 200 according to an embodiment of the invention for controlling an operating temperature of a module of the vehicle, as described above.

It can be appreciated from the above, that embodiments of the invention are used to predict utilisation of a module in advance such that the operating temperature of the module can be controlled in advance, rather than responsive to actual utilisation of the module. In one particular embodiment, an operating temperature of a vehicle engine is controlled responsive to an estimated duty cycle of the engine which may, advantageously, lead to improved operation of the engine, such as improved efficiency or power output.

It will be appreciated that embodiments of the present invention can be realised in the form of hardware, software or a combination of hardware and software. Any such software may be stored on a computer readable medium. The software may be tangibly stored on the computer-readable medium.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1-32. (canceled)

33. A thermal control method for a vehicle, comprising:
determining, based on a location of a vehicle and digital map data, an estimate of at least one vehicle operating condition at one or more future points in time;
determining a utilization parameter indicative of utilization of a module of the vehicle based on the estimate of the at least one vehicle operating condition;
determining, for each of the future points in time, a desired operating temperature for the module of the vehicle based on the determined utilization parameter; and
controlling, in advance of at least one of the future points in time, one or more thermal control means associated with the vehicle to direct an operating temperature of the module to the desired operating temperature at the at least one of the future points in time.

34. The method of claim 33, wherein the desired operating temperature of the module is determined to be inverse to the utilization parameter.

35. The method of claim 33, wherein
the module of the vehicle is one of a power unit or power train of the vehicle;
the power unit comprises one or more of an engine and electric motor; and
the power train comprises a gearbox of the vehicle.

36. The method of claim 33, wherein the thermal control means is a thermostat associated with the module and the controlling comprises controlling a set-point of the thermostat.

37. The method of claim 33, wherein the controlling comprises determining a control time, in advance of the at least one of the future points in time, to control the thermal control means such that the operating temperature is directed toward the desired operating temperature at the at least one of the future points in time.

38. The method of claim 37, wherein the control time is determined based on the utilization of the module preceding the at least one of the future points in time.

39. The method of claim 37, wherein the controlling is based upon a thermal response model for the module, the thermal response model being indicative of a temporal relationship of the operating temperature of the module to operation of the thermal control means.

40. The method of claim 39, wherein
the control time is determined based on the thermal response model and one or more attributes of the module, such that the operating temperature of the module is directed toward the desired operating temperature at the at least one of the future points in time; and
the one or more attributes comprise a current temperature of the module.

41. The method of claim 33, wherein the utilization parameter is determined based upon a vehicle dynamics model for the vehicle.

42. The method of claim 41, wherein the utilization parameter is a duty cycle of the module and the vehicle dynamics model is indicative of a relationship between the at least one vehicle operating condition and the duty cycle.

43. The method of claim 33, wherein the at lest one vehicle operating condition comprises at least one of a vehicle speed, a vehicle gradient and a vehicle altitude.

44. The method of claim 33, wherein determining the estimate of at least one vehicle operating condition comprises predicting at least one future location of the vehicle at the one or more future points in time based on the digital map data.

45. The method of claim 44, wherein the at least one future location of the vehicle is predicted based on route information indicative of a route to be followed by the vehicle.

46. The method of claim 44, comprising determining a road category associated with the at least one future location and wherein the estimate of the at least one vehicle operating condition comprises an estimated speed of the vehicle at the at least one future location based on the road category.

47. The method of claim 33, wherein the digital map data comprises at least one of electronic horizon data and topology data.

48. A non-transitory storage medium containing computer software which, when executed by a computer, is arranged to perform the method of claim 33.

49. A thermal controller for a vehicle, comprising:
location determining means for determining a location of the vehicle;
processing means for determining an estimate of at least one vehicle operating condition at one or more future points in time based on digital map data stored in a memory means accessible to the processing means, the processing means being arranged to determine a utilization parameter indicative of utilization of a module of the vehicle based on the estimate of the at least one vehicle operating condition;
wherein the processing means is arranged to determine, for each of the future points in time, a desired operating temperature for the module of the vehicle based on the utilization parameter; and
wherein the processing means is arranged to control, in advance of at least one of the future points in time, one or more thermal control means associated with the vehicle to direct an operating temperature of the module to the desired operating temperature at the at least one of the future points in time.

50. The thermal controller of claim 49, wherein the location determining means comprises an input for receiving location data indicative of a geographic location of the vehicle.

51. The thermal controller of claim 49, wherein the processing means is arranged to control the one or more thermal control means by outputting data to initiate an operation of the thermal control means.

52. A vehicle comprising a thermal controller according to claim 49.
